(19) United States
(12) Patent Application Publication
(10) Pub. No.: US 2003/0069744 A1
(43) Pub. Date: Apr. 10, 2003

(54) Networked referral commission system

(76) Inventors: Rick G. Craig, South Jordan, UT (US); Carter L. Knapp, Salt Lake City, UT (US); Thomas E. Wright, Salt Lake City, UT (US)

Correspondence Address: THORPE, NORTH & WESTERN, L.L.P., P. O. Box 1219, Sandy, UT, 84091-1219, US

(21) Appl. No.: 10/081,742

(22) Filed: Feb. 22, 2002

Related U.S. Application Data
(60) Provisional application No. 60/271,269, filed on Feb. 24, 2001.

(51) Int. Cl. G06F 17/60

(52) U.S. Cl. 705/1; 705/37

(57) ABSTRACT

A method for referring a buyer from a referring marketer to a listing sales broker through a collective listing organization. The method includes the step of storing a plurality of sales listings from the listing sales broker in a database. Another step is displaying the plurality of sales listings from the database for a buyer through a computer network interface associated with each referring marketer. A further step is recording referral information entered into the computer network interface by the buyer who views the plurality of sales listings. The next step is transferring the referral information to the listing sales broker. An additional step is paying the collective listing organization a commission when the buyer purchases an item listed in a sales listing from the listing sales broker.

This application claims priority to Provisional Application Serial No. 60/271,269 filed Feb. 24, 2001 in the U.S. Patent Office.

### SPECIFICATION

1. Field of the Invention

The present invention relates generally to a referral commission system. More particularly, the present invention relates to providing real estate referral commissions for real estate brokers and agents through computer networks.

2. Background

Over the period of the last few decades, the real estate industry and many other industries have become more automated. Real estate agents and their brokers have been using computers and electronic databases to better serve their customers for several years. More recently, multiple listing services have been placing property data on their own web sites for public access. Also, national aggregators of real estate data and photographs advertise their sites to the public.

One major advantage of using the Internet for providing home buying, real estate, and mortgage acquisition information is that there are millions of people utilizing computers and the Internet to access this information. It is also expected that the number of people who will use the Internet to access home buying information may increase significantly in the next few years. Of individuals who have access to Internet connections, it is believed that a large portion of those web users have used or will use the Internet to shop for real estate. Internet users are willing to use the web for real estate information because it reduces the time required to identify and purchase a home as compared to traditional methods, and it is accessible at any time.

Examples of national aggregators are Realtor.com and Homeadvisor.com. These public listing services are located on web sites on the Internet and provide some public information about real estate and property listings. These listings can also provide contact information about the agent and/or broker who is listing the property. After a buyer views a listing, he has the option of contacting the broker or agent, who is listing the real estate, or contacting the buyer's own agent to find out more about the property. Unfortunately, an agent that has been working with the buyer is not likely to be the agent listing the property that interests the buyer. So if a buyer calls the listing agent, the agent that the buyer has been working with loses the sale. These web sites can completely circumvent the agent the buyer has been working with or the original realtor who referred the buyer to that public web site.

These lost sales and other issues have caused many brokerages to create their own company or brokerage web sites. These web sites typically include real estate listings that are being listed exclusively through the brokerage providing the web site. For example, Brokerage One may have a web site that includes all the electronic listings for real estate that are being offered only by Brokerage One agents. This is important because Brokerage One real estate agents can then refer their buyers to Brokerage One's web site, and all the commissions for the sale of a property listed on that web site are given to Brokerage One, assuming the buyers end up using a Brokerage One agent or broker for their transactions. Of course, this is only true if the buyer purchases one of the Brokerage One properties listed on the web site. Another important function of a brokerage web site is that it contains agent profiles to aid a real estate buyer or seller in finding a real estate professional to help them. A brokerage web site may also contain mortgage information that allows the real estate brokerage to be involved in the sale of mortgage products.

One of the major drawbacks for a traditional brokerage web site is that it contains only real estate listings that are exclusive to that brokerage. Buyers look at the listings on a single brokerage web site to find a property to purchase but more often than not, the buyers do not find what they want because one brokerage's listings generally represent only a fraction of what is available in the marketplace. Buyers then go to web sites owned by other brokerages and look at those brokers' listings. This process can be time consuming and frustrating for buyers because they have to search for multiple brokers' web site addresses and then search each broker's site.

As the buyers continue their search, the original brokerage web site that attracted their attention in the first place may be completely forgotten. Alternatively, buyers may look at public multiple listing service web sites or national aggregators, but this also entails tracking down the brokerage or agent listing the property they are interested in. In either case, buyers' agents may be circumvented during this process as buyers end up contacting the listing agent or brokerage of a property they want to see.

The National Association of Realtors (NAR) has mandated that by Jan. 1, 2002, an Information Data Exchange (IDX) be available through all MLS providers so that real estate brokers can publish all other brokers' listings on their own web sites. Although an IDX is good for consumers, many brokers are concerned that this initiative may cause buyers to contact their competitors after visiting their web sites. IDX has not addressed the issue of procuring cause so vital to the real estate industry because the listing brokerage firm's name will legally have to be listed, and in some cases its phone number will be published as well. Furthermore, the IDX offers no guarantee of capturing buyers' contact information for brokers or agents.

Internet users and consumers are starting to expect more information from a single source, whether that is one brokerage or one web site. They want to be able to access an Internet site where they will be provided quality, traditional service by a real estate agent or broker they trust. Real estate buyers also want to be able to access one web site that provides all the information they need during their real estate search. Brokerages who do not have extensive electronic access for their clients tend to lose clients. It is believed that real estate professionals do not need to worry about losing their clients to the Internet, as previously thought, but that they should worry about losing clients to another real estate broker who has superior electronic and web site offerings.

It should also be noted that even though buyers are using the Internet to find information, the majority of these users or buyers end up using an actual real estate agent to complete their property transactions. Notwithstanding the power of the information on the Internet, however, very few real estate professionals receive leads from public online sources or from their online brokerage sources.

### BRIEF DESCRIPTION OF THE DRAWINGS

FIG. 1 illustrates that potential real estate buyers may be required to visit many brokers' web sites when they are interested in purchasing properties;

FIG. 2 illustrates the system of the present invention that allows a buyer to view listings of third party brokers through one broker's web site using a collective listings database;

FIG.3 is a block diagram illustrating a networked referral and commission system where a buyer accesses a sales broker's listings database;

FIG. 4 is a block diagram illustrating the networked referral and commission system where a buyer accesses multiple brokers' sales listings in a database that is linked to multiple brokers' computer interfaces or web sites;

FIG. 5 is a flowchart illustrating the steps involved in referring a buyer from a first broker's web site to a second broker's listing data, and the second brokerage providing a referral fee to the collective listing organization, to be split with the referring broker when any transaction is closed with the buyer;

FIG. 6 is a flow chart that illustrates the steps involved in allowing a buyer to search a referring broker's website and generating a referral fee due from the listing broker to the collective listing organization, to be split with the referring broker when the buyer purchases any property from the listing broker;

FIG. 7 depicts a screen in a user interface provided by the collective listing organization that allows a buyer to select the state where they desire to purchase real estate;

FIG. 8 depicts the screen a user is presented to narrow a real estate search to a specific city, zip code, square footage, number of bedrooms, number of bathrooms, type of property and/or price range;

FIG. 9 illustrates the screen presented to a buyer to narrow the search in FIGS. 7 and 8;

FIG. 10 illustrates the search results provided to a buyer when searching on a given criteria;

FIG. 11 illustrates a screen for a buyer to register by submitting information that will enable the buyer to receive more information about specific electronic real estate listings;

FIG. 11A illustrates an information screen that is displayed when a user does not enter valid contact information;

FIG. 12 illustrates the information provided to a buyer after contact information has been provided;

FIG. 13 depicts the scheduling calendar shown when a buyer requests a personal showing of a property by selecting “Personal Showing” in FIG. 12, or “Schedule a Personal Showing” in FIG. 10;

FIG. 13A depicts the screen shown to a buyer after a Personal Showing is requested;

FIG. 14 is a flow chart of steps taken in the present real estate referral system to provide a referral from a referring broker to a listing broker;

FIG. 15 depicts the various options presented to a broker upon successful log-in and the leads referred to the broker;

FIG. 16 illustrates a screen display of referrals referred to the broker;

FIG. 17 illustrates the display of past and upcoming (respectively) scheduled Personal Showings for a broker or agent;

FIG. 18 illustrates a display of buyer details for a lead or referral when selecting a buyer from FIGS. 15,16,17;

FIG. 18A illustrates a display screen of the listings or properties that a buyer is interested in;

FIG. 18B illustrates the contact action that the broker or agent has taken with respect to the interested buyer;

FIG. 19 illustrates a search screen with filtered search results for the broker administration tool.

### SUMMARY OF THE INVENTION

The invention provides a method for referring a buyer from a referring marketer to a listing sales broker through a collective listing organization. The method includes the step of storing a plurality of sales listings from the listing sales broker in a database. Another step is displaying the plurality of sales listings from the database for a buyer through a computer network interface associated with each referring marketer. A further step is recording referral information entered into the computer network interface by the buyer who views the plurality of sales listings. The next step is transferring the referral information to the listing sales broker. An additional step is paying the collective listing organization a commission when the buyer purchases a sales listing from the listing sales broker. In one embodiment of the invention, the method is applied to the purchase of real estate.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

The Internet has enabled buyers and sellers to perform sales transactions online without personally meeting with the individual on the other side of the transaction. This is especially true of Internet retail web sites where millions of items are sold without actual human interaction.

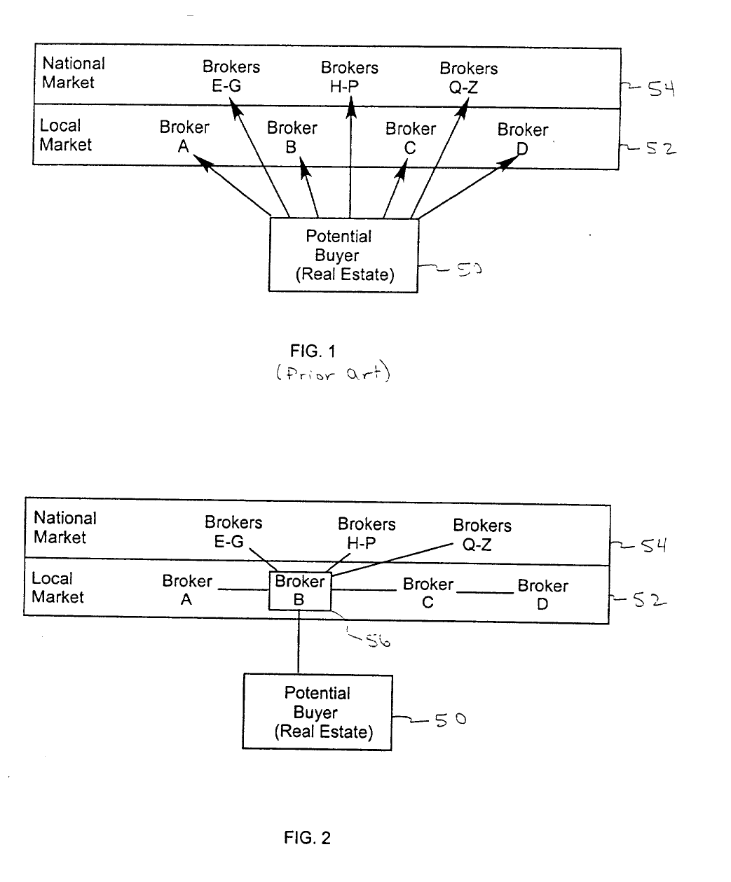

In the area of more expensive items, people desire and sometimes need personal interaction with the buyer and/or seller of those high-priced items. For example, FIG. 1 illustrates that a potential real estate buyer may need to contact many real estate brokers when the buyer is searching for a property to purchase. A buyer's initial contact with each of these brokers may be through an electronic web site. This initial Internet research will frequently be followed up by an in-person contact or telephone contact.

When a buyer 50 is performing an out-of-state real estate search, this means a buyer can first contact a broker from a local market 52 to determine if the broker has listings from another state. If the buyer does not find what he looking for, the buyer may also contact brokers in the national market 54. Unfortunately, if the buyer finds a property through a national market broker, then the local market broker can be circumvented. This is especially true where the local market broker may be the buyer's agent. Of course, this means that the local market broker may lose a potential transaction involving the buyer with whom they were originally involved.

FIG. 2 illustrates a system that allows a buyer 50 to contact third party brokers 52 through their original broker 56. Contacting other local market brokers or national market brokers through an original broker allows that broker to retain the buyer as a client. This involves the original broker in the sales transaction with a buyer whether or not the buyer purchases a listing listed with the original broker. In order to implement the relationship outlined in FIG. 2, a system and method are described in the present invention that allow a buyer to be referred to third party brokers through their original broker, thus enabling the original broker to benefit from a client's purchase.

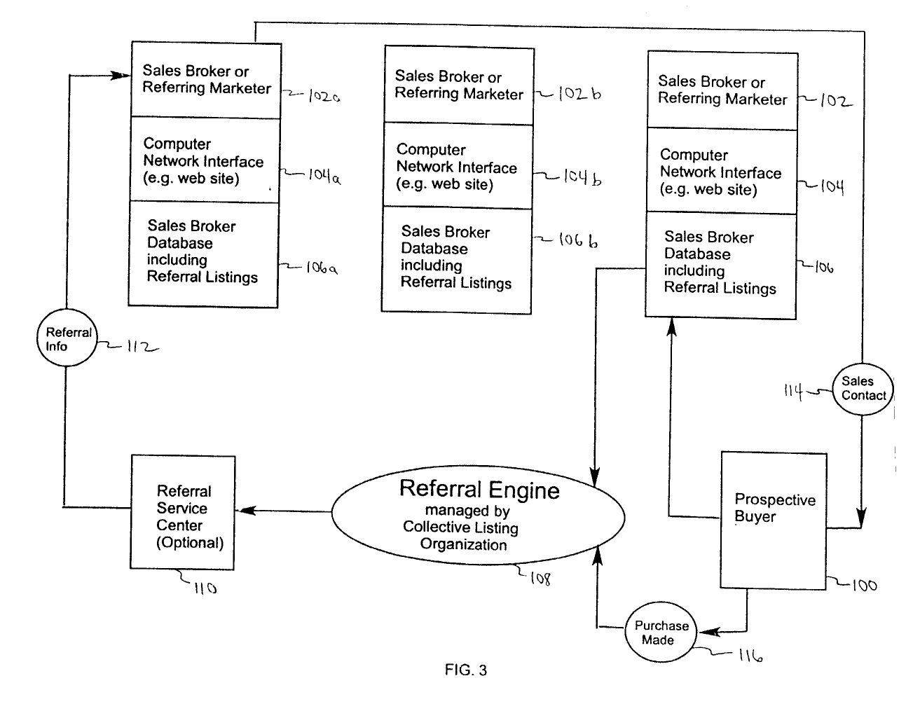

FIG. 3 is a block diagram illustrating a networked referral and commission system including a method for a prospective or current buyer 100 to access a sales broker's listing database 106. The buyer 100 first comes in contact with a sales broker 102 either personally, through an advertisement, an Internet search, or a similar means. The buyer then accesses a computer network interface 104 provided by the sales broker. It should also be mentioned that the sales broker could be a referring marketer. A referring marketer is an entity that does not have any actual listings, but markets listings for other brokers. When the buyer accesses the network interface or web site, the buyer is able to view a sales broker database.

The sales broker database 106 includes listings for the sales broker and other brokers who are members of a collective listing organization. A sales broker who has listings in the database is generally defined as a listing sales broker. When a buyer accesses a listing in that belongs to the respective broker who owns the web site or computer network interface through which the buyer accesses the database, a lead is generated for that broker. When a buyer accesses a listing in the broker's database that is another broker's listing 102a, 102b) who does not own the web site or computer network interface through which the buyer is accessing the database, a referral is generated for that listing broker. These referral listings are significant because they allow brokers to generate additional referral sales that were not available through their separate databases. Not only do brokers capture sales for leads on their own listings, but they also are involved in referring sales to other brokers. This means that they are involved in transactions with other brokers, in which they would not have otherwise been involved, and earn income they would not otherwise earn. To produce these referrals, referring sales brokers promote their own web sites in order to drive traffic there. This referral system allows a buyer to access a broker's web site and see the individual broker's listings as well as thousands of other brokers' listings in the system.

If a buyer 100 finds a property listing on the broker's database 106 that the buyer is interested in, the buyer can access that referral listing by selecting or clicking on it. A buyer then enters the buyer's contact information that is requested by a referral engine 108. Entering the buyer's contact information allows the buyer to access more detailed information about sales listings. The referral engine is managed by the collective listing organization. The collective listing organization requests contact information including the buyer's name, telephone number and e-mail address.

This contact information is processed before it is sent as a referral to the listing broker 102a. A customer service center 110 qualifies the referral information by further verifying it before sending it on to the listing broker 102a. The referral service center qualifies this information by contacting the buyer 100 to determine if the buyer is ready to list or purchase a property in the very near future, within a few months, or not at the current time. The qualification or filtering step as implemented by the customer service center is an optional step because the buyer's contact information can be sent directly to the sales broker without any qualification. However, it has been generally found that the referrals generated by buyers through the referral engine should be further qualified to ensure that the referrals passed to the listing broker are buyers who are actually ready to list or purchase a property.

After the referral information 112 has been qualified by the customer service center 110, the information is transferred to the listing broker 102a, who has that listing. The listing broker receives the referral information 112 from the referral engine 108 through an e-mail message, through a referral viewing utility in the sales broker's web site, or another electronic method. The listing broker takes this information and makes personal sales contact 114 with a buyer. This online referral system eliminates the potentially frustrating process that buyers encounter of tracking down a listing agent and phone number. In the case of a real estate listing, the personal contact can include the additional steps of showing a property to the buyer, negotiating a sales contract, and completing the necessary legal documents to close the sale. This system also eliminates brokers' frustration at losing potential clients who visit their web sites. Even if they do not sell the buyer one of their own brokerages' listings, they can at least earn referral income by referring the buyer to another brokerages' listings.

After the buyer has made a purchase 116 from the listing sales broker, a referral fee is paid from the listing sales broker 102a to the collective listing organization that manages the listing database and referral engine. This referral fee has conventionally been 25% of the referred side of the commission. The collective listing organization then pays one-half of the referral commission to the referring broker 102. Although the referral fee preferably retained by the collective listing organization is 12.5%, other referral fee amounts or percentages may be set and other commission structures may exist.

The listing sales broker 102a also has its own computer network interface 104a or web site that is connected to a sales broker database 106a maintained by the collective listing organization. The sales broker database includes the broker's own listings and listings from other sales brokers, including the sales listing in which the buyer 100 is interested.

FIG. 3 illustrates that the sales brokers each have a sales broker database 106, 106a, 106b, contains sales listings. Each sales broker can have an exact duplicate of the database, which is accessible through its computer network interface or web site. This way the database may be hosted at each sales broker's web site. The sales broker database may be an entire database replicated for the site or it may be a cross-link to other sales brokers' databases.

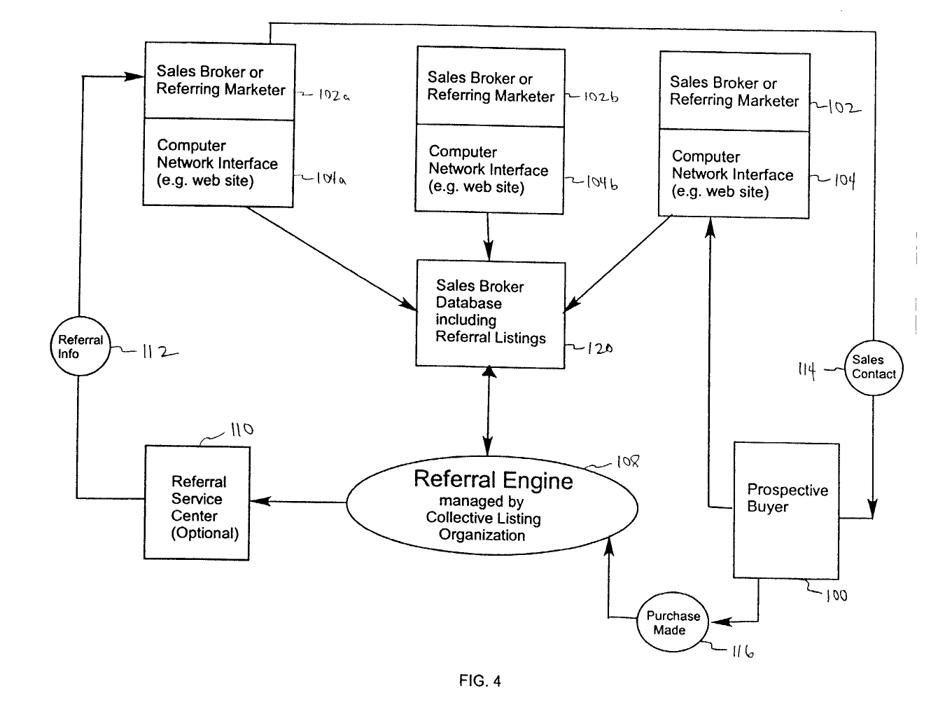

FIG. 4 illustrates a sales broker database 120 that is located at a central location. The sales broker database in FIG. 4 is independently managed by the collective listing organization 108 and is accessible to the buyer 100 through each of the sales broker's or referring marketer's computer network interfaces 104, 104a, 104b. This way each sales broker acts as a transparent portal to the aggregate sales broker database. This preferable configuration provides the advantage that a single entity manages the central sales broker database. Furthermore, the buyer must pass through the centrally managed sales broker database to access the referral engine 108, which can prevent the sales brokers from circumventing the referral engine process. High-speed computer hardware is used to host the sales broker database, which also provides an economy of scale. A fast, centralized database engine is also implemented, so the buyer can have high speed listing access even if the sales broker has a relatively slow web site (i.e. low data transfer rate).

This real estate referral system also provides significant advantages for real estate buyers. One of the advantages for buyers is the simplified electronic searching of multiple brokers' real estate listings. Many real estate buyers use a broker's web site to obtain area and property information. Instead of finding several brokers' web sites and accessing them each one by one, buyers can simply visit one referring broker's web site to see a comprehensive listing of local and national properties, regardless of which broker owns the listings.

Another advantage exists for buyers who are moving to another city. These buyers may explore listings in their own area to determine competitive pricing for a property they plan to sell, and search for new properties in their destination city. By accessing a referring broker's web site, they can be assured that they are viewing a comprehensive product offering, not just a fragment of the market.

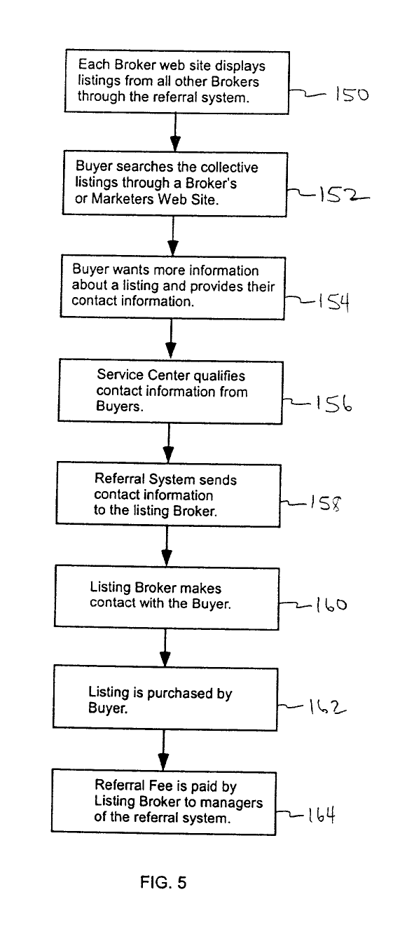

FIG. 5 illustrates a method for referring buyers from a referring broker or marketer to a listing broker through a collective listing organization. A first step is that each member broker website displays the listings from all other brokers through the referral system 150. This is done by storing a plurality of sales listings from each of the sales brokers in a database managed by the collective listing organization. The next step is that a buyer searches the collective listings through a broker's or marketer's web site 152. If the buyer finds a listing that the buyer is interested in, then the buyer provides the buyer's contact information to the referral engine. The buyer is required to provide detailed contact information in order to view further detailed information about the sales listing or real estate 154.

The referral information is stored in the collective listing organization's database and forwarded to a service center, which qualifies the referral information from buyers 156. The service center contacts the buyer leads and referrals received from the referral engine to determine if they are valid and/or qualified buyers. The criteria the service center uses for qualification and filtering can include, but are not limited to, whether buyer contact information is actually valid and correct, when the buyer intends to purchase, credit history, appointment availability, and whether the buyer would like contact from a broker's sales agent.

After the lead or referral has been qualified by the service center, the referral system sends the referral information to the listing broker 158. The listing broker is then able to view the referral information for the buyer. The listing broker then makes contact with the buyer 160. The listing broker discusses any sales listings with the buyer that the buyer is interested in, and arranges a meeting with the buyer and/or provides other information to the buyer. When contact with the buyer has been made, the buyer can purchase the listing from the listing broker 162. When the purchase is completed, the listing broker pays a referral fee to the collective listing organization, which operates or manages the referral system 164. The collective listing organization forwards one-half of this referral fee to the referring brokerage or marketer.

Although this embodiment of the invention is directed toward the real estate market, it should be realized that this specific referral and commission method and system could also be used to sell other sales listings. For example, the sales broker may sell other items such as vacation timeshares or list other properties to be sold. The actual item in the database does not affect the flow of the referral data and commission splitting, implemented by this invention. The present method is also significantly different from prior art methods where a web site refers a visitor to a retail web site and receives a commission for that referral. The present system allows the collective listing organization to provide a referral service through a collective database that it manages and receives a portion of the referral commission from the referring party. This present system can be used where there is a listing agent who controls the property that will be purchased and there is a referring agent who will come in contact with the buyer and refer that purchase to the listing agent through the collective listing organization.

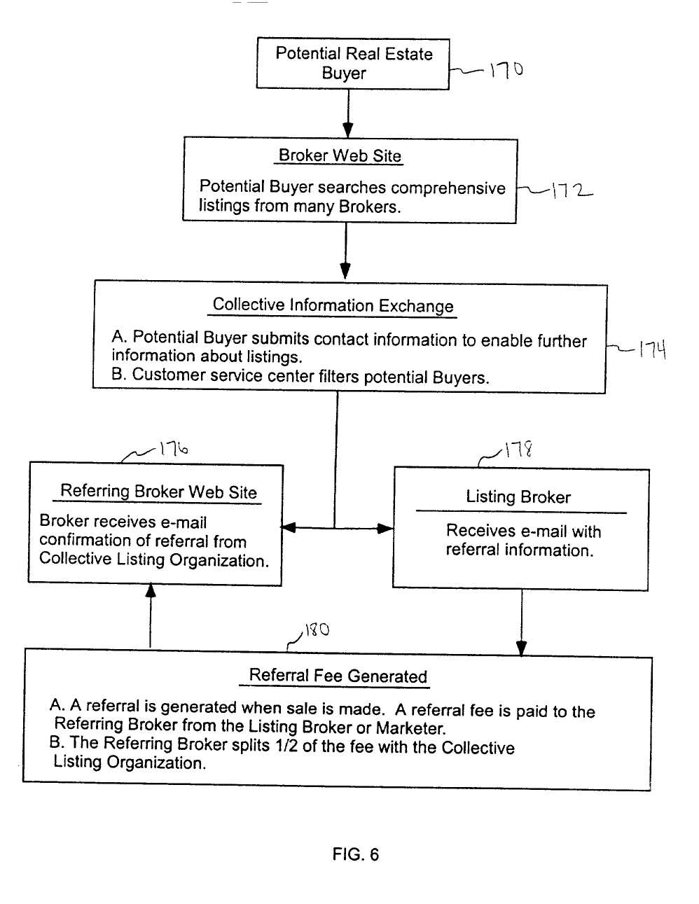

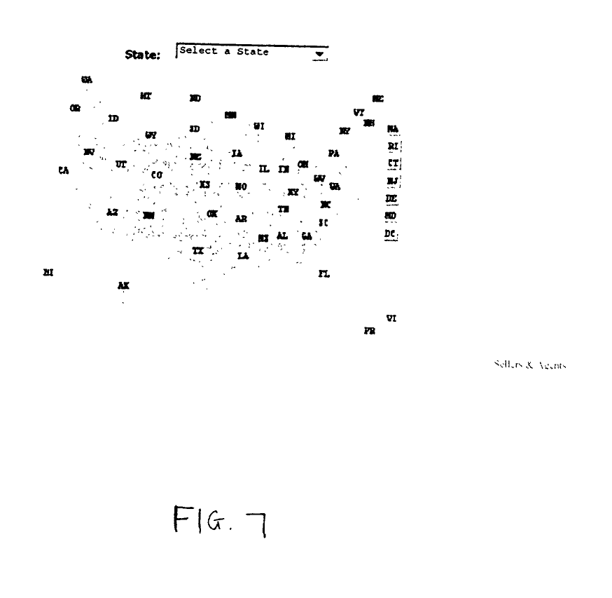

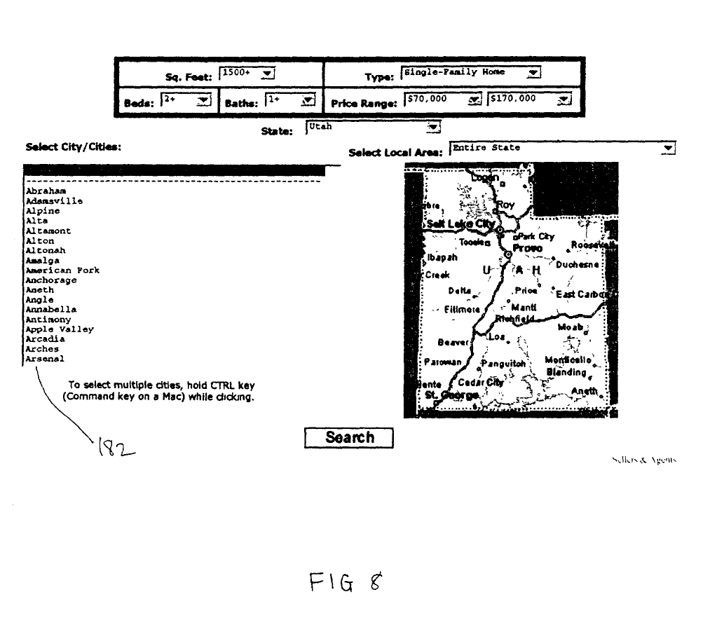

FIG. 6 is a flow chart that illustrates further details related to the implementation of this invention for real estate listings. The flow chart depicts the steps involved in allowing a buyer to access a referring broker's web site and generate a referral when the buyer purchases a property from the listing broker. The potential real estate buyer 170 enters the system through a referring broker's web site 172. The buyer searches the comprehensive listings that include the listings from a plurality of brokers. The broker's web site will preferably be connected to a centralized database that is hosted separately from the broker's web site. Alternatively, the real estate listings may be hosted along with the real estate broker's web site.

When the potential real estate buyer desires further information about the real estate listing the buyer wants to view, the buyer will provide the buyer's contact information to the collective information exchange 174. The buyer's contact information is then submitted to the referral system, which enables the display of further information about the real estate listings. One important part of the listing that is not initially provided to the potential real estate buyer is the actual address or listing agent of the property. This information is provided to the potential real estate buyer after the buyer has submitted personal contact information to the collective information exchange. This referral information is recorded through the web site or computer network interface and is then sent to a customer service center that qualifies or filters the buyer's information.

The customer service center receives the referral information from all member brokers and lead information for brokers who desire the filtering services. A referral coordinator contacts the referred buyer to determine the buyer's needs. Some buyers do not need or want agent services. Other buyers desiring further information or services generally fall into two categories. The first group is those who want a real estate agent to work with them now. The second group is buyers who are not yet ready to work with an agent, but may be interested in working with an agent in a few months. This second category goes into a follow-up system for the referral coordinator to make follow-up contact until the person is ready for an agent. As described before, this filtering process weeds out contact information that is inaccurate or false, and enables the customer service center to determine when this buyer desires to actively pursue the provided sales listings.

When a buyer desires to work with an agent, the referral coordinator contacts the referred broker for an agent assignment. When provided by the broker and the agent, the assigned agent's profile or resume is e-mailed to the referred buyer. The assigned agent receives the buyer referral information and a list of properties viewed during the buyer's search 178. The agent is obligated to contact the buyer and provide the needed service to aid in buying and/or selling a property. The broker or agent records the status of the referred person until the referral is closed or lost.

The listing real estate broker can receive the referral information via e-mail. In addition, the referring real estate broker can receive an e-mail, which confirms that the referral information has been processed by the collective exchange organization. In other words, an e-mail can be sent to the referring broker that indicates a referral has been passed on to a listing broker.

When a buyer purchases real estate as a result of the referral information, a referral fee is generated 180. The listing real estate broker pays the referral fee to the collective information exchange, which forwards one-half of the fee to the referring broker or marketer.

Notwithstanding the power of the Internet, online services are not enough to sell real estate. The referral of buyers to brokers and their agents still makes the difference. That is why a web site that includes aggregated listings from many brokers enhances an individual broker's Internet presence. This type of aggregated information captures more leads and generates incremental referral income for all the brokers involved. Furthermore, it connects customers to live qualified real estate agents, an important service that brokers provide online or offline.

Another advantage of this system is that a real estate referral system provides direct benefits to the brokers who use it. Brokers receive referral income that they would otherwise not earn because buyers may visit a broker's web site without ever contacting the broker. Buyers will typically search listings of various brokers until they find what they are looking for, and the real estate referral system tracks these previously lost leads for the broker whose web site originally attracted the buyer. Thus, referral revenue generated would not have been realized without the real estate referral system. This system allows brokers who attract buyers to their web sites to earn referral fees from the sale of listings that are not their own.

Traditionally, brokerages have hosted only their own listings on their web sites. Because a single broker's listings represent only a fraction of the available properties in the market, it is mathematically improbable that buyers will find what they are looking for on a particular broker's site. When the buyer does not find what the buyer is looking for on one broker's web site, the buyer then continues to search on other broker's web sites, if the buyer knows other web addresses. When, after extensive searching, a buyer discovers a property for which the buyer wants more information, the buyer contacts that listing's broker, which leaves the broker who generated the original web site visit nothing.

A comprehensive web site provides more exposure for each broker's listings, and brokers benefit from enormous additional exposure at no extra cost. Many more buyers are exposed to brokers' listings and that makes selling their own properties easier and faster than before. The original referring brokerage protects its commissions and referral fees, even though it is providing buyers to other brokers.

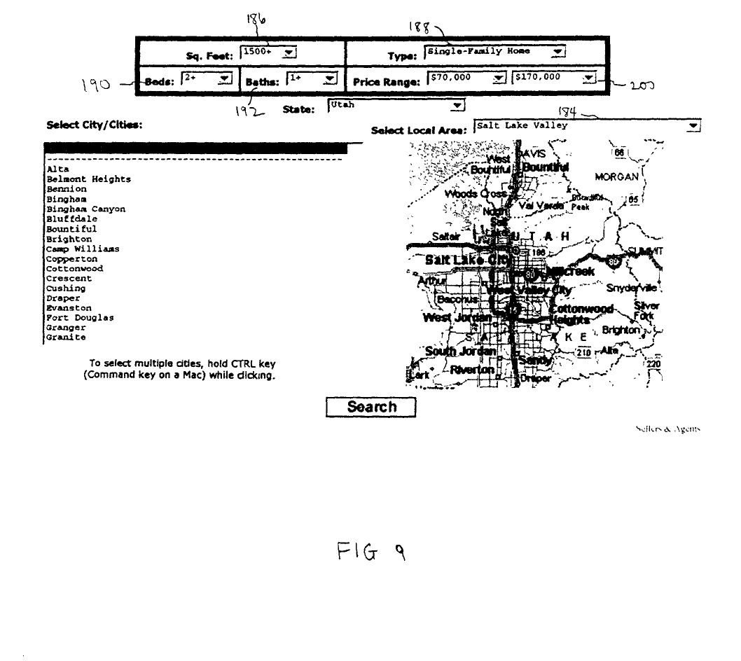

FIG. 7 depicts a screen from a portion of the user interface as provided by the collective information exchange. This screen allows a buyer to select a state where the buyer desires to purchase real estate. In a preferred embodiment of the invention, the collective information organization provides a search interface and search engine that is presented to the buyer. The search interface can be configured so that the search interface is supplied or formatted by the real estate broker's web site and then the referral is processed through the referral engine.

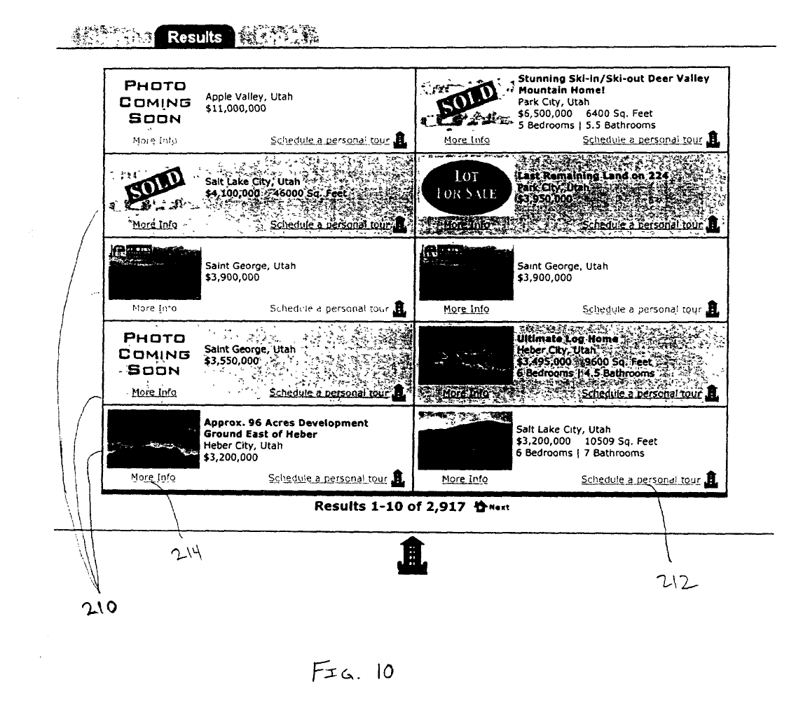

FIG. 8 depicts a screen that the buyer is presented in order to narrow the buyer's real estate search to a specific city, zip code, square footage, number of bedrooms, number of bathrooms, type of property and/or price range. The user is also able to select one or more cities 182 within which the buyer can search for a property.

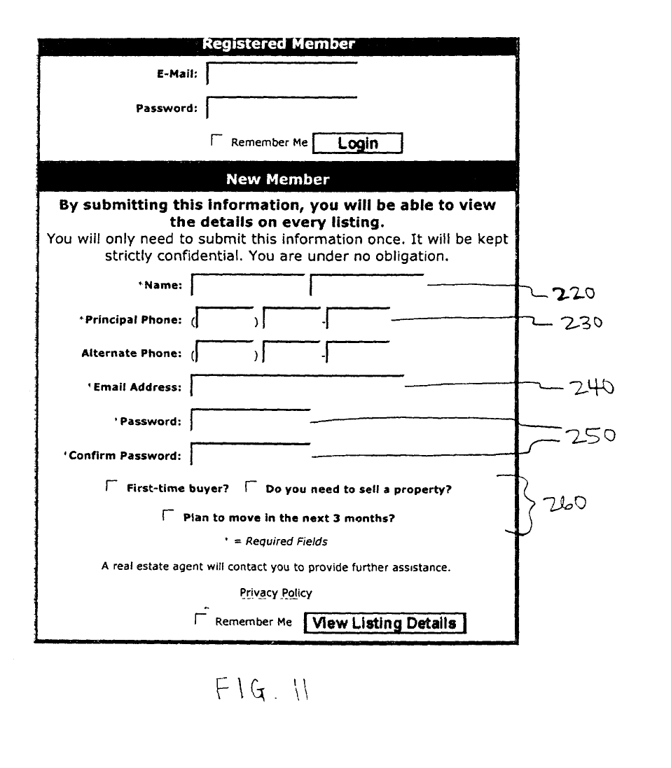

FIG. 9 illustrates a screen presented to the buyer that allows him to further narrow the search criteria. Specifically, the search criteria listed allow the buyer to select a city or local area as defined by certain regions 184. The search criteria also allow a buyer to narrow the property specific criteria for the properties the buyer desires to view. These criteria include the number of square feet in the property 186, the type of structure 188, the number of bedrooms 190, the number of bathrooms 192, and a price range for the real estate 200. The criteria listed here can be varied depending on preference and whether the real estate is residential, commercial, etc.

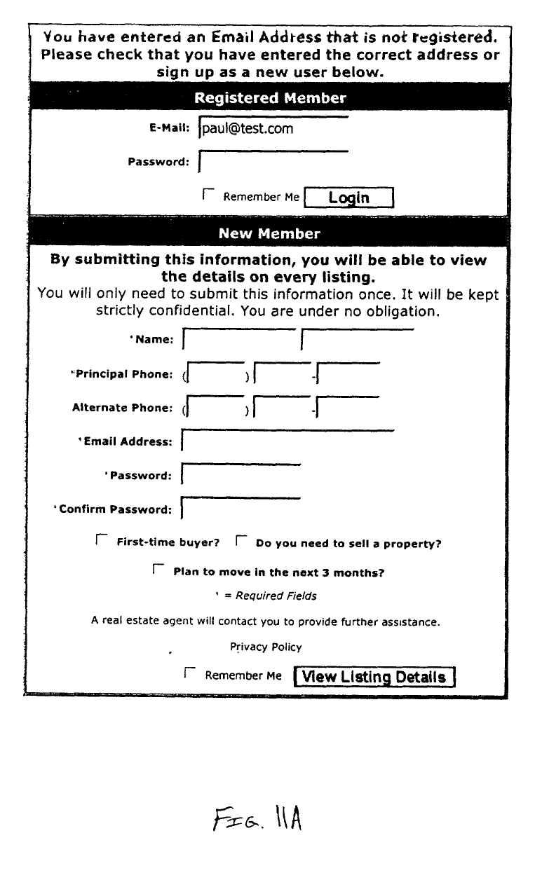

When the buyer has selected search criteria, properties will be returned by the database to match those criteria. FIG. 10 illustrates real estate search results that can be presented to a buyer based on the criteria the buyer selected. The search entries 210 returned by the database include information about the general property location, such as the city and state. The listing also includes the price of the property, square footage, number of bedrooms, number of bathrooms, and price, but further detailed information is not given until the buyer provides the buyer's contact information. The buyer may also schedule a Personal Showing of the property listing 212.

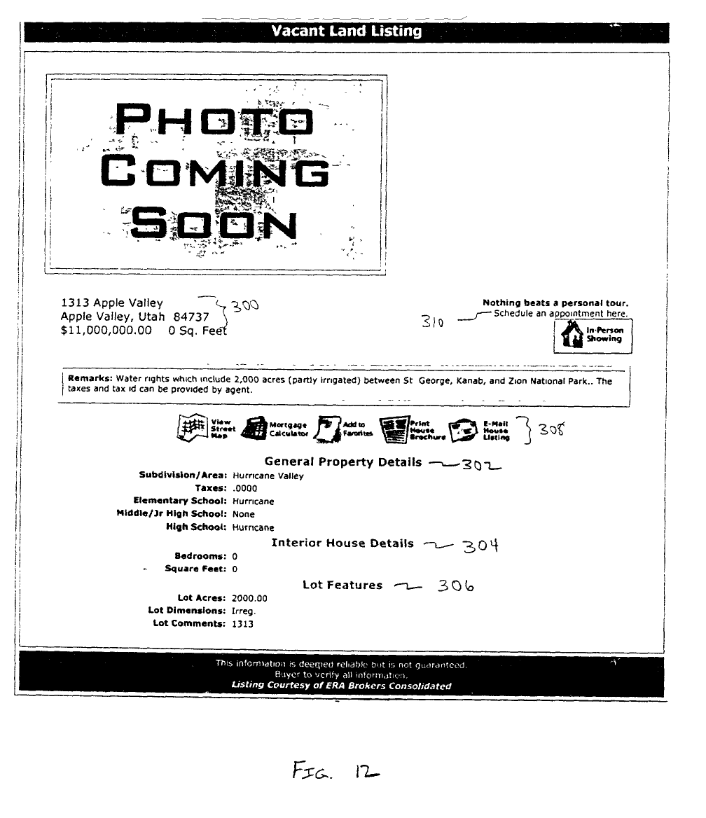

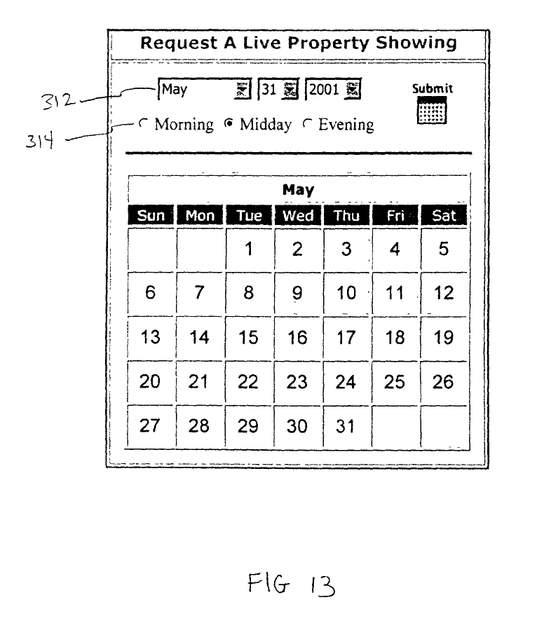

When the buyer clicks on the “More Info” link or button 214, as in FIG. 10, a contact information screen will be displayed as depicted by FIG. 11. FIG. 11 illustrates the information requested from the buyer in order to receive more detailed information about the online real estate listings. The buyer must provide the buyer's name 220, a principal phone number 230, and a valid e-mail address 240. The system can also be password protected 250, if desired, by the user or the collective listing organization. Additional information about the real estate buyer's status may be requested, such as whether the purchaser is a first-time buyer, whether the buyer is selling a property, or whether the buyer plans to move in the next three months 260. After the buyer has entered this personal contact information, a password allows him to enter the system and view more detailed information about the real estate listings. Another embodiment of the invention does not allow the buyer to enter a password, but a password is e-mailed to the user to verify the buyer's e-mail address before further information is disclosed. The user can alternatively be identified in a cookie stored in the web browser.

FIG. 11A illustrates an error screen that is displayed when the buyer does not enter valid contact information. At a minimum, the system can check to determine if the domain entered by the buyer is a valid domain. Further checks can be applied such as sending an e-mail to the buyer or calling the individual to verify the buyer's information.

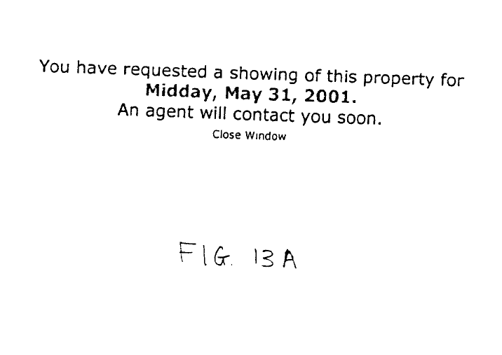

FIG. 12 illustrates a detailed real estate listing that is provided to a buyer after the buyer has submitted referral information. An important piece of information provided in this detailed real estate listing is the property street address 300. Further, other general property details 302, interior property details 304, and lot features 306 are provided. In addition to property details, the detailed real estate listing screen can also provide access to additional functionality to aid a buyer. For example, additional functions can be provided such as a viewable street map, a mortgage calculator, a property brochure, and the ability to e-mail listings to another interested party 308. Another feature of this invention is that the detailed listing provides the opportunity to schedule a Personal Showing 310.

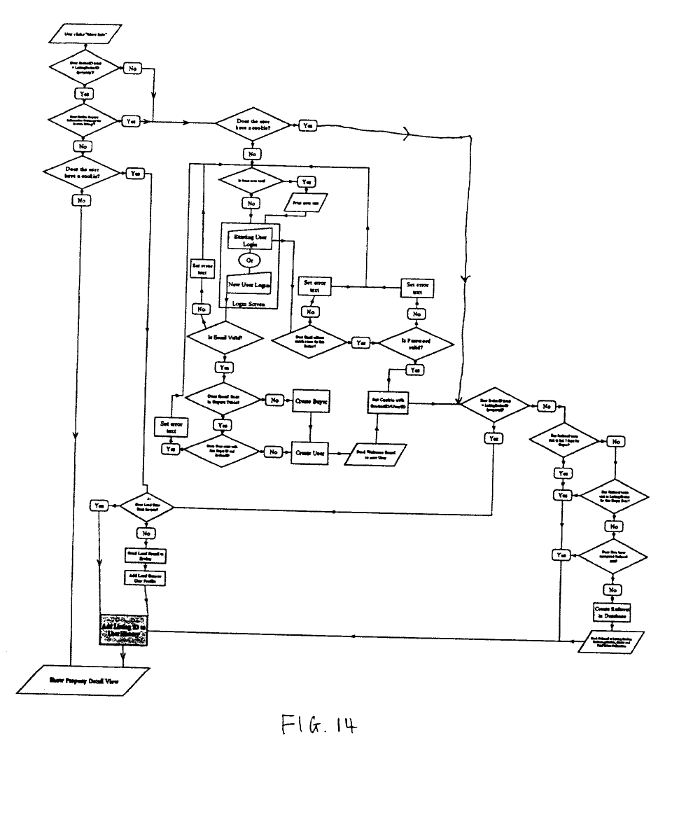

When the buyer clicks on the Personal Showing link or button, the buyer can be presented with the screen shown in FIG. 13. This Personal Showing component contains a calendar that allows a buyer to request a date and time for a Personal Showing (physical in-person showing) of the property listing the buyer is currently viewing. The buyer selects a date 312 when the buyer would like to view the property, and a general time when the buyer would like to visit the property. For example, the buyer may select morning, mid-day or evening as a tentative time for a personal showing. The personal showing information is sent to the listing real estate broker through the referral engine. Alternatively, the personal showing request is routed via the customer service center, which can then contact the buyer personally and schedule a specific time with a broker's agent to see the property.

The personal showing component can be a stand-alone component that is used separately from the referral engine. The personal showing component can be accessed via a link on an individual broker's web site, from a link associated with the referral engine, or the centralized sales broker database.

The personal showing component preferably resides on the same server(s) as the centralized sales broker database and referral engine. A link is then provided from the broker's web site to the personal showing component. Buyers are identified in the system using an information exchange and cookie system. If the user is new or logged out, the system requires contact information to be entered and a cookie is placed on the buyer's computer to identify the buyer in the future.

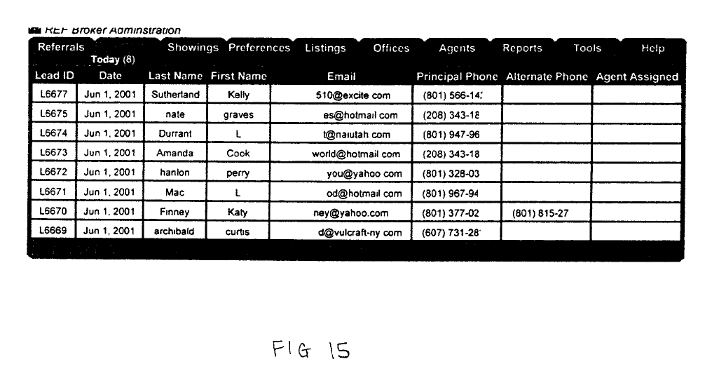

One significant advantage of allowing a user to request a personal property showing is that buyers who select this option are ready to immediately schedule an appointment with the listing broker's real estate agent. This can qualify the lead or referral without the need for sending the referral information to a customer service center. FIG. 13A is the response screen shown to a buyer after the buyer has requested a personal showing. It indicates to the user that a real estate agent for the specific property will contact the buyer soon. FIG. 14 is a flowchart of computer program steps that can be taken in the present real estate referral system to provide a referral from a first brokerage to a second brokerage.

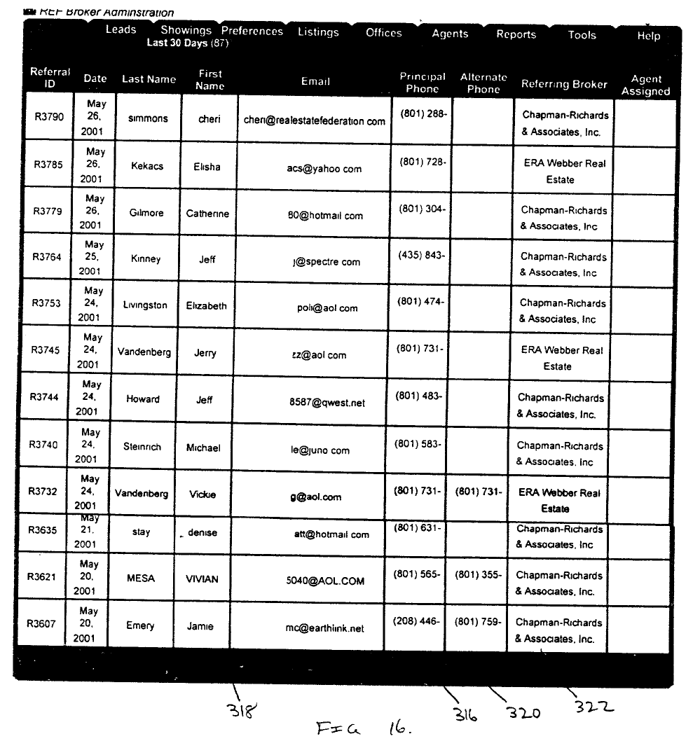

Another component of the present embodiment allows a listing real estate brokerage to access the referral information sent to them via an electronic interface such as a browser. FIG. 15 depicts the options presented to a listing broker after successfully logging in to the collective information exchange or referral engine in order to view referral information. It should be realized that the buyer's contact information generated through the referral engine can be stored in a database accessible to the listing brokers. As discussed previously, the brokers may have this referral information e-mailed directly to them or they may access a central storage database through a web interface. Alternatively, the collective information exchange and customer service center may send the information to a local database that is accessible to the listing real estate broker.

FIG. 15 illustrates a number of leads provided to a listing broker. Leads are buyers interested in listings where the referring broker and the listing broker are the same. In other words, if a buyer accesses a listing through a broker's network interface or web site and that broker owns the listing, then the referral information is a lead for the broker.

In some situations, a listing broker may not need to pay the collective information organization for leads generated in this manner. For example, if the leads are routed directly back to the listing broker without qualifying them, then an agreement may be made that the broker will not pay a referral fee. If the customer service organization filters the leads for the listing broker, then the listing broker will pay a commission to the collective listing organization for that service.

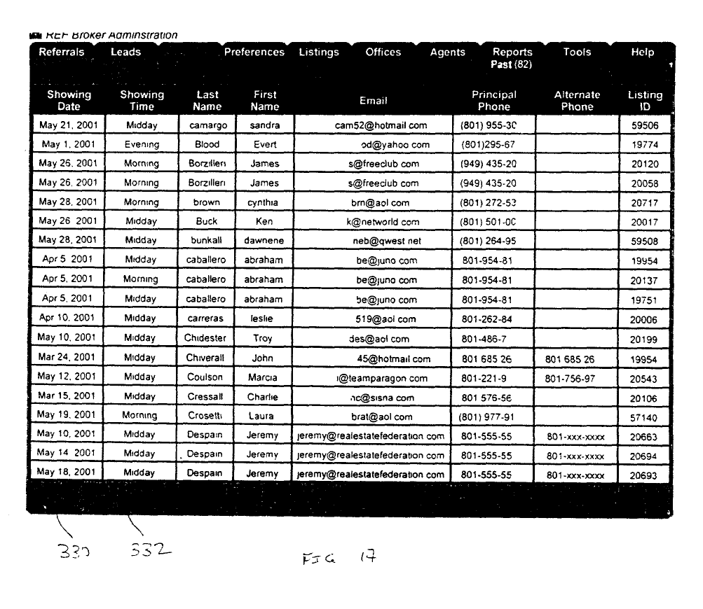

FIG. 16 illustrates referrals received by a listing broker after logging into the broker administration tool. Referrals are contact information from buyers that were referred to the listing broker from a separate, referring broker. These referrals can be qualified by the customer service center, just as the leads are qualified or filtered. A real estate broker or broker's real estate agent who accesses this information knows that the referrals are separated from leads, which aids them in the discussion they will have when they contact those referrals (i.e. buyers). The real estate agent assigned to these referrals may contact the buyers by their principal phone number 316, e-mail 318, or an alternate phone number 320. In this example screen, the referring broker is shown 322, which allows the listing broker or real estate agent to discuss with the buyer which broker they were referred from and whether or not they have a buyer's agent.

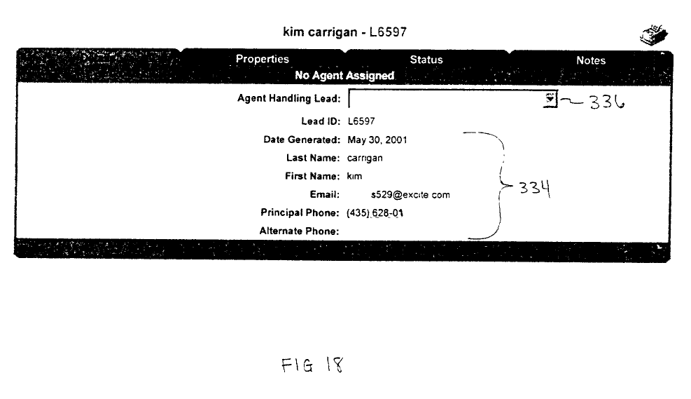

Brokers and their agents can see requested personal showings by logging into the broker administration tool with a username and password. The brokers and agents can see information gathered from buyers including names, phone numbers, e-mail addresses and any properties the buyers are interested in seeing. Brokers and agents can also be notified via e-mail at the time the personal showing request is made. FIG. 17 illustrates a screen display of upcoming or past personal showings that have been scheduled. A listing shows the showing date 330 and the showing time 332. Further information about the buyer's first and last name, e-mail address, principal phone number, and other information can be displayed. The broker or real estate agent may view past real estate showings by clicking on the button 334. The upcoming showings may be displayed by clicking on the button 336.

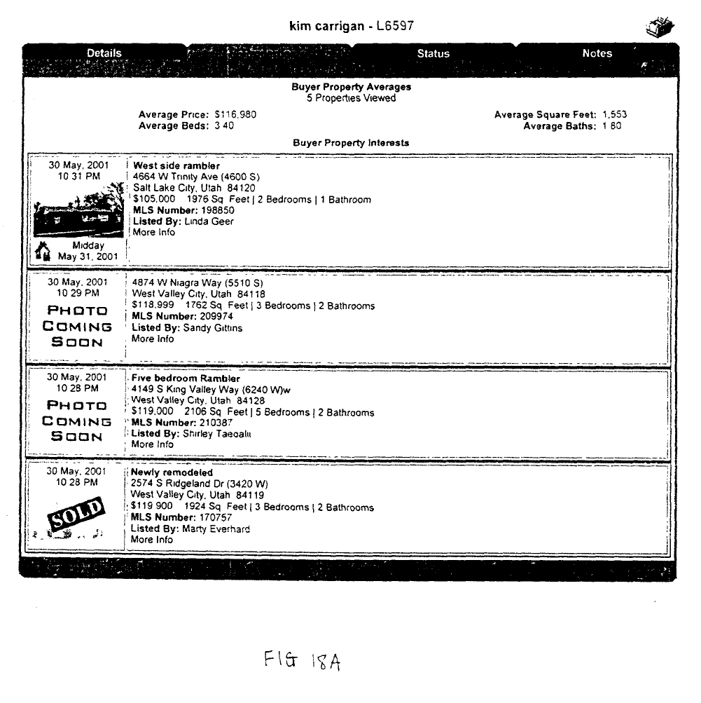

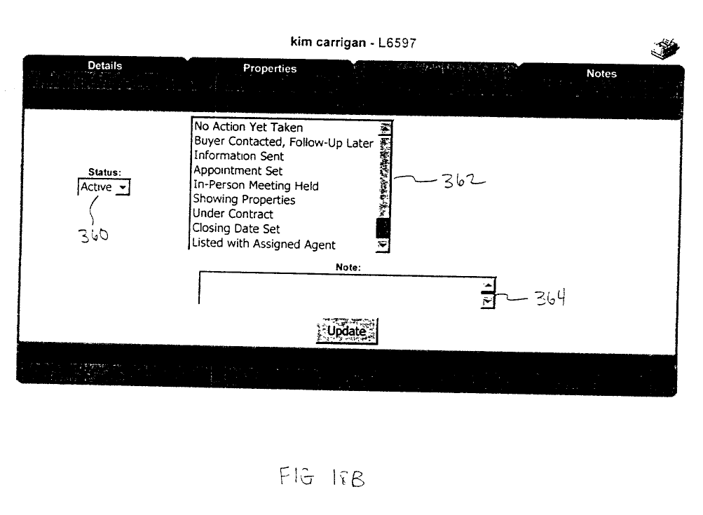

FIG. 18 illustrates a display screen containing buyer details for a lead or referral. This screen can be displayed for a selected buyer from the broker management screens illustrated in FIGS. 15, 16 and 17. In addition to displaying contact information 334, the screen also indicates a real estate agent who will handle the lead may be assigned by the broker 336. FIG. 18A illustrates a screen display of properties or listings in which a buyer indicated interest. This screen can be accessed from FIG. 18 or her screens where a buyer's name is in a list such as FIGS. 15-17. Specifically, the properties in this list can be listings that a buyer selected during a session (or sessions) after providing the buyer's contact information. These real estate listings can be organized based on a buyer-provided priority or some other criteria, such as which real estate listing was accessed first or most often, and statistical information such as average price, square footage, etc.

FIG. 18B is a screen that records the action a real estate agent has taken with respect to a buyer. When a real estate agent or broker accesses the screen, he can select the status 360 of a buyer, such as whether the buyer is active, inactive, or pending. The real estate agent or broker can also select other actions, such as whether information was sent, the buyer was contacted, no action was taken yet, or any other activities listed on-screen 362. The real estate agent may add a free form note to record the status of the buyer or other details 364.

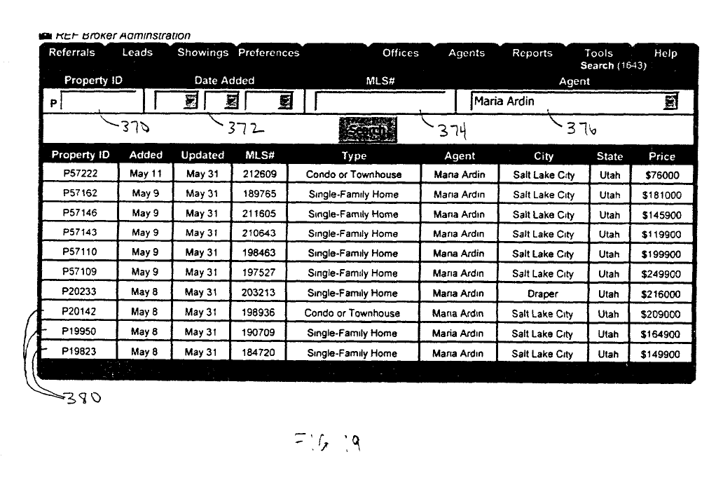

FIG. 19 illustrates a search screen with filtered results from the broker administration tool. This viewing screen allows a broker or an administrator from the collective listing organization to view the contacts made by property ID 370, the date the real estate listing was added 372, the Multiple Listing Service number 374, or the listing real estate agent 376. This window specifically allows a listing real estate broker or database administrator to manage the real estate entries that have been included in the database. Each row may also be clicked on for further information about that property such as a photograph, property information, structure information, etc.

Now more than ever, an important part of a real estate broker's marketing mix must be up-to-date electronic and Internet marketing. Brokers who belong to an association of referring brokers can promote their expanded local and national capabilities and enhance the power of their electronic listings and web sites to both buyers and sellers. In this type of arrangement, brokers' marketing of their web sites continues to substantially benefit them individually, and benefits referring brokers as a group.

Belonging to a collective listing organization provides many benefits and services to brokerage companies. First, brokers receive an increased market reach, which would be unobtainable without prohibitive marketing costs. In addition, referring brokers or organization members can all benefit from collective advertising and marketing that directly benefits each broker. As part of the present real estate referral system, brokers can use a listing database with up-to-date listings from every brokerage that is using the system. Significant savings can also be realized from the pooled use of technology resources.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in implementation, form, function and manner of operation, and use may be made, without departing from the principles and concepts of the invention as set forth in the claims.

What is claimed is:

1. A method for referring a buyer from a referring marketer to a listing sales broker through a collective listing organization, comprising the steps of:
storing a plurality of sales listings from the listing sales broker in a database;
displaying the plurality of sales listings from the database for a buyer through a computer network interface associated with each referring marketer;
recording referral information entered into the computer network interface by the buyer who views the plurality of sales listings;
transferring the referral information to the listing sales broker; and
paying the collective listing organization a commission when the buyer purchases a sales listing from the listing sales broker.

2. A method as in claim 1, further comprising the step of paying the referring broker a portion of the commission for electronically referring the buyer to the listing broker, when the buyer purchases a sales listing from the listing broker.

3. A method as in claim 1, further comprising the step of paying the referring marketer a portion of the commission for electronically referring the buyer to the listing sales broker, when the buyer purchases the sales listing from the listing sales broker.

4. A method as in claim 1, further comprising the step of paying a commission to the collective listing organization to be split with the referring broker when the buyer purchases a sales listing from the listing broker.

5. A method as in claim 1, further comprising the step of paying the collective listing organization a referral fee that is owed by the listing broker to the collective listing organization and the referring broker or marketer when the buyer purchases a sales listing from the listing sales broker.

6. A method as in claim 1, further comprising the step of paying the collective listing organization one half of a referral fee for the sale by the listing sales broker to the referring marketer when the buyer purchases a sales listing from the listing sales broker.

7. A method as in claim 5, further comprising the step of paying the collective listing organization a 12.5% referral fee of the sale of the item listed in the sales listing to the buyer.

8. A method as in claim 5, further comprising the step of recording contact information entered by the buyer who desires further information about at least one property listing.

9. A method as in claim 1, further comprising the step of requiring a buyer to enter referral information to access detailed information about a sales listing.

10. A method for referring a real estate buyer from a referring real estate broker to a listingreal estate broker through a collective listing organization, comprising the steps of:
storing a plurality of real estate listings from the listing real estate broker in a database managed by the collective listing organization;
displaying the plurality of real estate listings to thereat estate buyer from the database through a listingreal estate broker's computer network interface associated with each referringreal estate broker;
recording referral information entered into the computer network interface by thereal estate buyer who views the plurality of real estate listings;
sending the referral information to the listing real estate broker; and
paying the collective listing organization a commission when the real estate buyer purchases real estate from the listing real estate broker.

11. A method as in claim 10, further comprising the step of paying a commission to both the referring real estate broker and the collective listing organization when the real estate buyer purchases a real estate listing from the listing sales broker.

12. A method as in claim 10, further comprising the step of paying the collective listing organization a commission when the real estate buyer purchases the real estate listing related to the referral information sent to the listing real estate broker.

13. A method as in claim 10, further comprising the step of paying the collective listing organization one half of a referral fee paid by the listing real estate broker to the referring real estate broker when the real estate buyer purchases real estate from the listing real estate broker.

14. A method as in claim 13, further comprising the step of paying the collective listing organization a referral fee of 12.5% of the commission from a sale of the real estate listing to the real estate buyer, who provided the referral information.

15. A method as in claim 10, further comprising the step of paying the referring real estate broker a commission for electronically referring the real estate buyer to the listing real estate broker, when the real estate buyer purchases the real estate listing from the listing real estate broker.

16. A method as in claim 10, further comprising the step of recording referral information entered by the real estate buyer who desires further information about at least one of the plurality of real estate listings.

17. A method as in claim 10, further comprising the step of displaying the plurality of real estate listings to the real estate buyer from the database through a web site associated with each referring real estate broker.

18. A method as in claim 10, further comprising the step requiring a real estate buyer to enter referral information to access detailed information about a real estate listing.

19. A method as in claim 10, wherein the step of paying the collective listing organization a commission, further comprises the step of paying the collective listing organization only for referrals from the referring real estate broker to the listing real estate broker that are not owned by the listing real estate broker.

20. A method as in claim 10, wherein the step of paying the collective listing organization a commission, further comprises the step of paying the collective listing organization for referrals from the referring real estate broker to the listing real estate broker and leads that are owned by the listing real estate broker.

21. A method as in claim 10, wherein the step of paying the collective listing organization a commission, further comprises the step of paying the collective listing organization only for referrals from the referring.
